(19) United States
(12) Patent Application Publication
(10) Pub. No.: US 2012/0330888 A1
(43) Pub. Date: Dec. 27, 2012

(54) DATA BACKUP DEVICE

(76) Inventor: Arnaldo Zael Cruz, Miami, FL (US)

(21) Appl. No.: 13/535,354

(22) Filed: Jun. 27, 2012

Related U.S. Application Data
(60) Provisional application No. 61/501,669, filed on Jun. 27, 2011.

(51) Int. Cl. G06F 17/00; G06F 1/16

(52) U.S. Cl. 707/610; 361/679.31; 707/E17.001

(57) ABSTRACT

A data backup device is built into a device charging mechanism to provide automated data backup when a device is charged. Such a system results in regular data backups, as most users consistently charge their devices, such as their cell phones, smart phones, tablet computers, and the like. The charger/data backup device can integrate into a wireless network to provide remote access and additional backup options. The charger/data backup device can be configured to move data between electronic devices from multiple manufacturers or between electronic devices having different operating systems.

### CROSS-REFERENCE TO RELATED APPLICATIONS

This application claims the benefit of priority of U.S. provisional patent application No. 61/501,669, filed Jun. 27, 2011, the contents of which are herein incorporated by reference.

### BACKGROUND OF THE INVENTION

Cell phones, smart phones, tablet computers and other portable data devices have become more and more common among individuals. A large amount of data may be stored on these devices; however, few methods for backing up this data exist. Cloud computing technology may permit a user to back up their data on a remote server. While this type of backup may be useful, it requires the user to trust a third party with their data. Privacy and security issues may arise with the sharing of data to and from third parties.

Some devices permit the user to connect their device to a home computer or some other computing device. These devices require special software to access the data device and backup this data on the computing device. This type of system is often complex and requires intensive user intervention to insure a reliable backup. Often, users may not backup their devices' data due to the extra effort and time involved. Other times, users may backup their data, but only on occasion, or when they think to do so. This results in inconsistent backups and may result in loss of data.

As can be seen, there is a need for a data backup device that may be easy to use and allow the user to back up their data regularly.

### SUMMARY OF THE INVENTION

In one aspect of the present invention, a method for backing up data on a device comprises plugging a device charger into the device; and synchronizing data between the device and a data storage medium built into the device charger.

In another aspect of the present invention, an apparatus for charging an electronic device and backing up data from the electronic device comprises a first plug adapted to be inserted into a receptacle for receiving electrical power; a second plug adapted to fit into the electronic device to provide electrical power thereto; a memory device electrically connected to the second plug, the memory device adapted to receive data from the electronic device and to send data to the electronic device; and a wireless interface adapted to permit the apparatus to connect to a wireless network.

In a further aspect of the present invention, an apparatus for charging an electronic device and backing up data from the electronic device comprises a first plug adapted to be inserted into a receptacle for receiving electrical power; a second plug adapted to fit into the electronic device to provide electrical power thereto; a memory device electrically connected to the second plug, the memory device adapted to receive data from the electronic device and to send data to the electronic device; a wireless interface adapted to permit the apparatus to connect to a wireless network, wherein the wireless interface assigns the apparatus an internet protocol (IP) address, wherein the IP address permits data to be sent to and from the memory device without using the electronic device.

These and other features, aspects and advantages of the present invention will become better understood with reference to the following drawings, description and claims.

### BRIEF DESCRIPTION OF THE DRAWINGS

FIG. 1 is a schematic representation of an electronic device charging and back-up device according to an exemplary embodiment of the present invention; and

FIG. 2 is a schematic diagram showing data back-up options for devices that can operate with the electronic device charging and back-up device of the present invention.

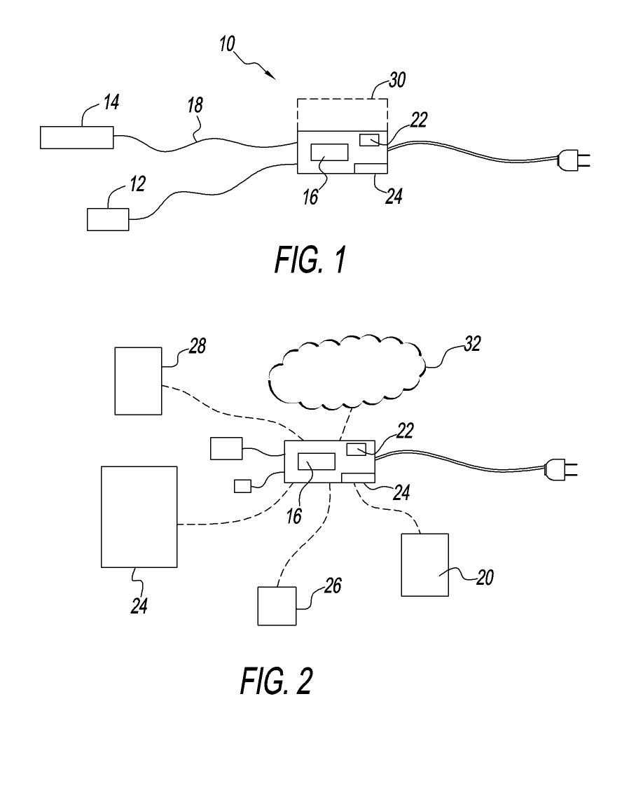

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an exemplary embodiment of the present invention provides a data backup device that is built into a device charging mechanism. By providing a charger with a data backup, when the user plugs in their charger, data may automatically be backed up. Such a system results in regular data backups, as most users consistently charge their devices, such as their cell phones, smart phones, tablet computers, and the like. In some embodiments, the data backup device may synchronize with video devices, such as smart televisions, to provide backup of and access to recorded television shows.

Referring to the Figures, a data backup device 10 may send and receive data through the same plug by which the device is charged. This may be, for example, a mini-USB type connector. In some embodiments, the data backup device 10 may have two plugs, a first plug 12 adapted to connect to charge the device, and a second plug 14 adapted to connect to send and receive to and from the device. The particular configuration will depend on the device.

In some embodiments, data storage medium 16, such as a solid state memory device, may be formed inline with the device's charging cable 18. The data storage medium 16 may range from about 1 gigabyte (GB) to about 64 GB or more.

When the user plugs in their device 20 into the charger 12 (and, optionally attaches the data backup plug 14), the data storage medium 16 may include a processor (not shown) and software to determine data added, removed or changed since the last charge and may synchronize the data between the device and the data storage medium. This may permit the data storage medium 16 to act as a backup for data on the device. This data may include contact lists, text messages, pictures, video, music, applications, chat messages, tweets, social media posts and the like.

The device 20, such as a smart phone, may be programmed with an application that may permit the user to choose data to be backed up, a time to make the backup, the frequency of backups and the like. The application may be designed for the particular operating system of the user's smart phone and may detect when the data backup device/charger is connected to the device.

The data backup device 10 may have settings to 1) permit the device to control synchronization, 2) permit the data storage medium to control synchronization, or 3) dual synchronization. In the first mode (the device controls synchronization), the data storage medium will be adjusted to match the device. This first mode may be the typical backup mode. This mode will move new data onto the data backup device and will delete items from the data backup device that have been deleted from the device. In the second mode (the data storage medium controls synchronization), the device will be adjusted to match the data storage medium. This mode may be useful to load contacts, video, pictures, and the like from the data backup device onto a new device, such as a new smart phone. In the third mode (dual synchronization), any new data on the data backup device will be moved to the device and any new data on the device will be moved to the data backup device. This mode may be useful when the data backup device is configured on a network and may, itself, receive data, as discussed below.

As mentioned above, the data backup device 10 may include a processor and computer readable medium adapted to store program code. The program code may, for example, control the various modes of operation, as described in the previous paragraph. Program code may be provided to read information from the device and recognize new or modified data. Program code may be provided to permit synchronization among different type of devices. For example, a contact may be added to an iPhone® and when the iPhone® is plugged into the data backup device/charger, the data storage medium may backup this new contact. An Android® based operating system smart phone may be plugged into the data backup device/charger and, if so programmed, the data backup device may send the updated contact to the Android® based smart phone. Program code may be provided to translate the data to and from a variety of languages and operating systems. In some embodiments, the system of the present invention may be useful to move files and data to and from conventional cellular phones and between conventional cellular phones and smart phones, for example.

The data backup device 10 can be designed to interact with television receivers, such as smart televisions, where the television can send a wired (Ethernet, for example) or wireless signal to the backup device 10, allowing the backup device 10 to save a television program for later upload to a mobile device.

The data backup device 10 may include various options to permit different types of data backup, for example. One such option may include a wireless transmitter/receiver 22 disposed in the data backup device 10. The data backup device 10 may be assigned a unique IP address and may permit the user to wirelessly backup data. Such a system may permit a user to provide a backup for the backup/charger of the present invention—by wireless transmitting the data to a server (such as the user's home computer, a cloud backup 32, or the like) that may or may not be on the same network. By having a unique IP address, a user may access their data on the backup device at any time, from any location with an internet connection, such as from a remote desktop computer 24. This may be useful if a user does not have their phone and desires to retrieve a contact's phone number, for example. Also, by having a unique IP address, the user may send information directly to the backup device for later synchronization with the mobile device. For example, a user may email a picture or a document to the backup device, or the user may scan a document or picture directly to the backup device. The backup device may be able to accept wireless data sent from one type of device (or a device with a first operating system) and allow another device (or a device with a different operating system) to receive this data, either wirelessly, or while charging the device.

The data backup/charger device 10 may have a port 24, such as a USB port for connecting the device to a separate device, such as a computer, a portable hard drive, or the like. This may permit creating a backup of the backup, for example, when a portable hard drive is plugged into the port. This may be an option when wireless networks are not available or when the device is not configured with a wireless transmitter/receiver.

The data backup/charger device 10 may, as described above, receive data. For example, when part of a wireless network, as shown in FIG. 2, a user may download photographs from a camera 26 to their desktop computer 24. The user may then opt to send one or more pictures to the backup device 10. When the user plugs in the charger/backup device into their device, the pictures may be automatically synchronized onto the device. The same procedure may work for contacts, for example. If a user receives a contact file via, for example, Microsoft Outlook®, the contact may be automatically sent to the backup/charger device which may automatically synchronize with the user's device when it is plugged in for charging.

In some embodiments, the backup device 10 can fully interact with various different data storage devices. For example, the backup device 10 can send and receive data from a user's cloud-based device backup system. This can be useful, for example, if the user has data already on a cloud-based backup system and wishes to use the charger/backup device 10 of the present invention. The user can instruct the backup device to retrieve information from their cloud-based backup and store this data locally.

In some embodiments, the data backup device 10 may be used for a plurality of devices 20, 28. For example, if a family has 3 iPhones®, they each may use the same or different data backup devices. If they use the same backup device, the backup device may recognize each iPhone® and synchronize each one appropriately.

In some embodiments, the data backup device 10 may include a power backup system. For example, a rechargeable battery pack 30 may be part of the data backup device 10, where the battery pack 30 may provide power to the device 20 when a power source is not available. The battery pack 30 may be useful for emergency cell phone power, for example.

As described above, the device may be any one of a number of devices used to store data, such as smart phones, cell phones, cameras, video recorders, e-readers, tablet computers and the like.

It should be understood, of course, that the foregoing relates to exemplary embodiments of the invention and that modifications may be made without departing from the spirit and scope of the invention as set forth in the following claims.

What is claimed is:

1. A method for backing up data on a device, comprising:
plugging a device charger into the device; and
synchronizing data between the device and a data storage medium built into the device charger.

2. The method of claim 1, further comprising assigning a network IP address to the data storage medium to permit remote access to data stored on the device.

3. The method of claim 1, further comprising charging a battery of the device via power provided by an AC plug.

4. The method of claim 1, further comprising charging a battery of the device via a rechargeable battery pack integrated with the device charger.

5. An apparatus for charging an electronic device and backing up data from the electronic device, comprising:
a first plug adapted to be inserted into a receptacle for receiving electrical power;
a second plug adapted to fit into the electronic device to provide electrical power thereto;
a memory device electrically connected to the second plug, the memory device adapted to receive data from the electronic device and to send data to the electronic device; and
a wireless interface adapted to permit the apparatus to connect to a wireless network.

6. The apparatus of claim 5, further comprising a data port to access the memory device, the data port permitting access to and from the memory device.

7. The apparatus of claim 5, further comprising an energy storing device adapted to charge the electronic device when the receptacle for receiving electrical power is not available.

8. The apparatus of claim 5, wherein the apparatus contains program code adapted to receive data into the memory device from a first electronic component and transmit data from the memory device to a second electronic component, wherein the first and second electronic components

9. The apparatus of claim 8, wherein the first and second electronic components operate on different operating systems.

10. The apparatus of claim 5, wherein the wireless interface assigns the apparatus an internet protocol (IP) address, wherein the IP address permits date to be sent to and from the memory device without using the electronic device.

11. An apparatus for charging an electronic device and backing up data from the electronic device, comprising:
a first plug adapted to be inserted into a receptacle for receiving electrical power;
a second plug adapted to fit into the electronic device to provide electrical power thereto;
a memory device electrically connected to the second plug, the memory device adapted to receive data from the electronic device and to send data to the electronic device;
a wireless interface adapted to permit the apparatus to connect to a wireless network, wherein the wireless interface assigns the apparatus an internet protocol (IP) address, wherein the IP address permits date to be sent to and from the memory device without using the electronic device.

12. The apparatus of claim 11, further comprising a data port to access the memory device, the data port permitting access to and from the memory device.

13. The apparatus of claim 11, further comprising an energy storing device adapted to charge the electronic device when the receptacle for receiving electrical power is not available.

14. The apparatus of claim 11, wherein the apparatus contains program code adapted to receive data into the memory device from a first electronic component and transmit data from the memory device to a second electronic component, wherein the first and second electronic components

15. The apparatus of claim 14, wherein the first and second electronic components operate on different operating systems.
